(19) United States
(12) Patent Application Publication
(10) Pub. No.: US 2012/0243059 A1
(43) Pub. Date: Sep. 27, 2012

(54) IMAGE READING APPARATUS

(75) Inventor: Hiroshi TANIMOTO, Toyokawa-shi (JP)

(73) Assignee: Konica Minolta Business Technologies, Inc., Chiyoda-ku (JP)

(21) Appl. No.: 13/426,168

(22) Filed: Mar. 21, 2012

(30) Foreign Application Priority Data
Mar. 24, 2011 (JP) 2011-065421

(51) Int. Cl. H04N 1/04

(52) U.S. Cl. 358/474

(57) ABSTRACT

An image reading apparatus having: a transparent plate having a first principal surface and a second principal surface; a carriage unit that carries a document such that the document passes through over the first principal surface; a reading unit that is opposed to the second principal surface and reads the document passing through a reading position on the first principal surface; a bump member that forms a bump on the first principal surface at a position more upstream than the reading position in a document carrying direction; and an adjustment unit for adjusting a distance in the carrying direction between the bump and the reading position for image reading of the document.

This appplication is based on Japanese Patent Application No. 2011-065421 filed on Mar. 24, 2011, the content of which is incorporated herein by reference.

### BACKGROUND OF THE INVENTION

1. Field of the Invention

The present invention relates to an image reading apparatus, and particularly relates to an image reading apparatus that reads a document carried to a reading position.

2. Description of Related Art

As a conventional image reading apparatus, for example, a document reading apparatus described in Japanese Patent Laid-Open Publication No. 2003-92662 is known. In the document reading apparatus described in Japanese Patent Laid-Open Publication No. 2003-92662, a document passing through the front surface of a reading glass is read at a reading position of the reading glass by a reading sensor located in the rear side of the reading glass. A bump member is arranged on the front surface of the reading glass more upstream in a document carrying direction than the reading position. In the document reading apparatus, this prevents the document from coming into contact with the reading glass, to prevent the reading glass from getting dirty from the document.

Incidentally, the document reading apparatus described in Japanese Patent Laid-Open Publication No. 2003-92662 reads a document by a CCD (Charge Coupled Devices) system. The CCD system has the advantages, for example, of permitting high-speed image reading. On the other hand, the CCD system requires a mirror for turning back an optical path due to a long focal distance of a lens arranged in front of a sensor. As a result, the CCD system has the drawback of causing upsizing of the document reading apparatus. In contrast to this, a CIS (Contact Image Sensor) is known. In an image reading apparatus adopted with the CIS system, for example, a CMOS is known as a sensor. The CIS system has the advantage of not requiring a mirror due to a short focal distance of a lens arranged in front of a sensor, to allow downsizing of the image reading apparatus.

However, the image reading apparatus adopted with the CIS system has a shallow focal depth, and thus the apparatus has a problem that only a slight deviation of the distance between the document and the sensor brings the document out of focus. For example, errors in the positions of the sensor, the lens and the like due to variations in manufacturing of the image reading apparatus cause blurring in a read image.

### SUMMARY OF THE INVENTION

An image reading apparatus according to an embodiment of the present invention includes: a transparent plate having a first principal surface and a second principal surface; a carriage unit that carries a document such that the document passes through over the first principal surface; a reading unit that is opposed to the second principal surface and reads the document passing through a reading position on the first principal surface; a bump member that forms a bump on the first principal surface at a position more upstream than the reading position in a document carrying direction; and an adjustment unit for adjusting a distance in the carrying direction between the bump and the reading position for image reading of the document.

### BRIEF DESCRIPTION OF THE DRAWINGS

FIG. 1 is a view showing an overall configuration of an image reading apparatus;

FIG. 2 is an enlarged view of a reading unit and its vicinity;

FIG. 3 is a sectional structural view along X-X of the reading unit of FIG. 2;

FIGS. 4A and 4B are enlarged views of a document passing through a reading position;

FIG. 5 is a sectional structural view of a reading unit of an image reading apparatus according to a first modification;

FIGS. 6A and 6B are enlarged views of a document passing through the reading position;

FIG. 7 is an enlarged view of a reading unit and its vicinity; and

FIG. 8 is a sectional structural view of a reading unit of an image reading apparatus according to a second modification.

### DETAILED DESCRIPTION OF THE PREFERRED EMBODIMENTS

### Configuration of Image Reading Apparatus

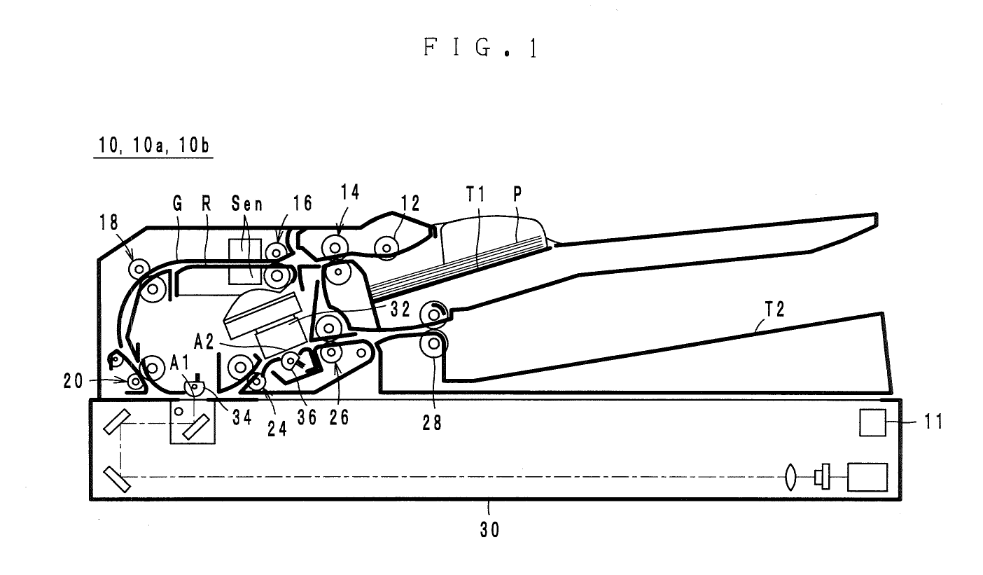

Hereinafter, a configuration of an image reading apparatus 10 according to an embodiment of the present invention will be described with reference to the drawings. FIG. 1 shows the overall configuration of not only the image reading apparatus 10 but also modified image reading apparatuses 10a and 10b.

The image reading apparatus 10 is an apparatus that allows a document to pass through over a platen glass by means of an ADF (Auto Document Feeder) mechanism, to read the document. As shown in FIG. 1, the image reading apparatus 10 is provided with a control section 11, a pickup roller 12, a paper feeding roller 14, carrier roller pairs 16, 18, 20, 24, 26, a paper ejection roller 28, reading units 30, 32, rollers 34, 36, a guide G, trays T1, T2, and a sensor Sen.

Documents P before subjected to image reading are loaded on the tray T1. The left end of the tray T1 can vertically swing with the right end thereof taken at the center. Specifically, when the document P is not to be taken out of the tray T1, the left end of the tray T1 is located in a lower position as shown in FIG. 1. On the other hand, when the document P is to be taken out of the tray T1, the left end of the tray T1 rises. In the following, in the state of the document P being loaded on the tray T1, the principal surface of the document P located on an upper side is referred to as a front surface, and the principal surface of the document P located on a lower side is referred to as a rear surface.

A plurality of guides G are provided in the image reading apparatus 10, and are members constituting a carrier path R for the document P. In FIG. 1, only a representative guide G is provided with a reference numeral. The carrier path R has a shape formed by rotating a U shape clockwise by 90 degrees.

The pickup roller 12 is provided on the upstream end of the carrier path R, and takes out the documents P on the tray T1 one by one, to feed them into the carrier path R. More specifically, at the time of reading the document P, the left end of the tray T1 rises. Thereby, the pickup roller 12 comes into contact with the topmost document P among the plurality of documents P loaded on the tray T1. The pickup roller 12 is rotated by a power source (not shown). Thereby, the document P is sent into the carrier path R by the pickup roller 12.

Each of the paper feeding roller 14 and the carrier roller pairs 16, 18, 20, 24 and 26 are configured by a pair of rollers facing each other across the carrier path R. The paper feeding roller 14 and the carrier roller pairs 16, 18, 20, 24 and 26 are provided so as to be arrayed in this order on the carrier path R, and carry the document P along the carrier path R.

At a reading position A1 of the carrier path R, a reading unit 30 reads the front surface of the document P passing through the reading position A1. The reading position A1 is located between the carrier roller pair 20 and the carrier roller pair 24. The reading unit 30 reads the front surface of the document P by the CCD system. Since the reading unit 30 has a conventional configuration, a further detailed description thereof will be omitted.

At the reading position A1, the roller 34 is opposed to the reading unit 30 across the carrier path R. The lower half of the roller 34 is a white cylinder. The upper half of the roller 34 is provided with a brush. The lower half of the roller 34 is to perform shading correction when the reading unit 30 reads the front surface of the document P. The upper half of the roller 34 is to clean the reading position A1 of the reading unit 30.

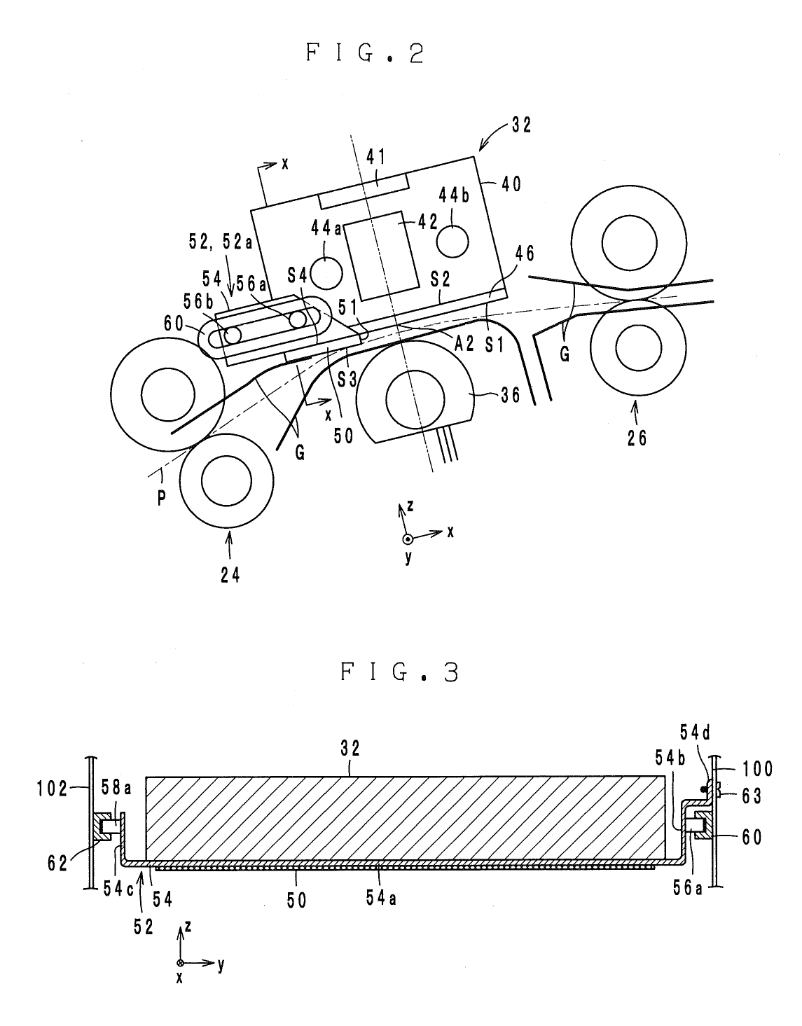

At a reading position A2 of the carrier path R, a reading unit 32 reads the rear surface of the document P passing through the reading position A2. The reading position A2 is located between the carrier roller pair 24 and the carrier roller pair 26. The reading unit 32 reads the rear surface of the document P by the CIS system. FIG. 2 is an enlarged view of a reading unit 32 and its vicinity. FIG. 3 is a sectional structural view along X-X of the reading unit 32 shown by FIG. 2. In FIG. 2, a direction in which the document P is carried below the reading unit 32 is defined as an x direction. Further, a horizontal direction as well as a direction orthogonal to the x direction is defined as a y direction. Moreover, a direction orthogonal to the x direction and the y direction is defined as a z direction.

The reading unit 32 reads the rear surface of the document P having been carried by the carrier roller pair 24, and includes a body 40, a sensor 41, a lens 42, light sources 44a, 44b, a glass (transparent) plate 46, a bump member 50, and an adjustment mechanism 52, as shown in FIG. 2.

As shown in FIG. 2, the body 40 is provided in the more positive side in the z direction than the carrier path R, and is a box with an opening on a negative side in the z direction. The body 40 accommodates a sensor 41, a lens 42 and light sources 44a and 44b.

As shown in FIG. 2, the glass plate 46, which is transparent, closes the opening of the body 40 on the negative side in the z direction, and the glass plate 46 has principal surfaces S1 and S2. The principal surface S1 is a surface located on the negative side in the z direction, and the principal surface S2 is a surface located on the positive side in the z direction.

As shown in FIG. 2, the carrier roller pair 24 carries the document P so that the document P can pass through on the principal surface S1. The carrier roller pair 26 carries the document P, which has passed through on the principal surface S1, to the tray T2. As shown in FIG. 2, between the carrier roller pair 24 and the carrier roller pair 26, the carrier path R is curved so as to protrude on the positive side in the z direction. Thereby, the carrier roller pairs 24 and 26 carry the document P in a curved state so as to protrude toward the glass plate 46. The document P is curved so as to be closest to the glass plate 46 at the reading position A2.

As shown in FIG. 2, the light sources 44a and 44b are provided inside the body 40, and emit light toward the reading position A2 on the principal surface S1. The lens 42 is an equal-magnification lens, and collects light that was emitted from the light sources 44a and 44b and reflected on the document P.

As shown in FIG. 2, the sensor 41 is a light-receiving element (e.g., CMOS) that is provided on the more positive side in the z direction than the glass plate 46 so as to be opposed to the principal surface S2, and reads the document P passing through the reading position A2 on the principal surface S1. More specifically, the sensor 41 is fixed to the inner peripheral surface of the body 40 located on the most positive side in the z direction. That is, the sensor 41 is provided on the more positive side in the z direction than the lens 42. Thereby, light having passed through the lens 42 is collected on the light-receiving surface of the sensor 41. As thus described, the sensor 41 reads the rear surface of the document P by the CIS (_{con}tact image sensor) system.

As shown in FIG. 2, the roller 36 is opposed to the reading unit 32 at the reading position A2, with the carrier path R in between. The upper half of the roller 36 is a white cylinder. The lower half of the roller 36 is provided with a brush. The upper half of the roller 36 performs shading correction when the reading unit 32 reads the rear surface of the document P. The lower half of the roller 36 cleans the principal surface S1 of the glass plate 46 of the reading unit 32.

The bump member 50 is provided to prevent the document P from coming into contact with the principal surface S1 while the document P is passing through the principal surface S1, thereby preventing the principal surface S1 from getting dirty. As shown in FIG. 2, the bump member 50 is a sheet that makes a bump 51 on the principal surface S1 at a position more upstream, with respect to the document P carrying direction, (i.e., on the more negative side in the x direction) than the reading position A2. More specifically, the bump member 50 is a sheet that has a predetermined thickness and has principal surfaces S3 and S4. The principal surface S3 is located on the negative side in the z direction and faces the carrier path R. The principal surface S4 is located on the positive side in the z direction and faces the glass plate 46. The principal surface S3 is located on the more negative side in the z direction than the principal surface S1 by the thickness of the bump member 50. The bump 51 is formed on the principal surface S1 of the glass plate 46. By formation of the bump 51, the document P, which is curved so as to protrude on the positive side in the z direction, comes into contact with the bump 51. Then, the document P is put down on the negative side in the z direction by the bump 51 so that the document P does not significantly protrude from the principal surface S3 to the positive side in the z direction, whereby the document P does not come into contact with the glass plate 46.

The adjustment mechanism 52 adjusts the distance in the carrying direction (i.e., in the x direction) between the bump 51 and the reading position A2 for reading of the document P. In the image reading apparatus 10, the adjustment mechanism 52 is a mechanism to move the bump member 50 in the x direction. As shown in FIGS. 2 and 3, the adjustment mechanism 52 comprises a holder 54, guide pins 56a, 56b, 58a, 58b, rails 60, 62, and a screw 63. FIG. 3 also shows side walls 100 and 102 of a housing of the image reading apparatus 10. In FIGS. 2 and 3, a guide pin 58b is hidden and thus not shown.

As shown in FIG. 3, the holder 54 is a member having a U-shaped cross section with an opening on the positive side in the z direction when seen from the negative side in the x direction. More specifically, the holder 54 is made up of a bottom section 54a, side sections 54b, 54c, and a fixed section 54d. The bottom section 54a is a rectangular plate that is located on the negative side from the reading unit 32 in the z direction and that extends in the y direction. Both sides of the bottom section 54a in the y direction protrude from the reading unit 32. Further, the bump member is fitted to the principal surface of the bottom section 54a on the negative side in the z direction.

The side sections 54b and 54c are respectively connected to the ends of the bottom section 54a on the positive side and on the negative side in the y direction, and the side sections 54b and 54c extend to the positive side in the z direction. The fixed section 54d is connected to the end of the side section 54b on the positive side in the z direction, and is located on the more positive side in the y direction than the side section 54b. The fixed section 54d will be described later.

As shown in FIGS. 2 and 3, the guide pins 56a and 56b protrude from the side section 54b to the positive side in the y direction. As shown in FIG. 2, the guide pin 56a is located on the more positive side in the x direction than the guide pin 56b.

As shown in FIGS. 2 and 3, the guide pins 58a and 58b protrude from the side section 54c to the negative side in the y direction. The guide pin 58a is located on the more positive side in the x direction than the guide pin 58b.

The rail 60 is fixed to the side wall 100 of the housing, and configured by two parallel rail members extending in the x direction. The guide pins 56a and 56b are inserted in the two rail members constituting the rail 60. The rail 62 is fixed to the side wall 102 of the housing, and configured by two parallel rail members extending in the x direction. The guide pins 58a and 58b are inserted in the two rail members constituting the rail 62. Thereby, the guide pins 56a, 56b, 58a and 58b can slide in the x direction along the rails 60 and 62. Accordingly, the holder 54 and the bump member 50 can slide in the x direction. Consequently, the adjustment mechanism 52 can adjust the distance in the carrying direction (i.e., in the x direction) between the bump 51 and the reading position A2 for image reading of the document P.

The screw 63 fixes the fixed section 54d to the side wall 100 of the housing. Thereby, the holder 54 is fixed to the image reading apparatus 10, and the bump member 50 is fixed to the image reading apparatus 10.

The paper ejection roller 28 outputs the document P, having been carried by the carrier roller pair 26, to the tray T2. The document P, which has been subjected to image reading, is loaded on the tray T2.

The sensor Sen is provided between the carrier roller pairs 16 and 18 on the carrier path R, and acquires information on the stiffness of the document P. In the image reading apparatus 10, specifically, the sensor Sen acquires information on the thickness of the document P. It is to be noted that, although the sensor Sen is not particularly used in the image reading apparatus 10 according to the present embodiment, it is used in an image reading apparatus 10b according to a modification which will be described later.

In the image reading apparatus 10 configured as above, for example, when the focal point of the reading unit 32 deviates due to an error in fabricating the reading unit 32 and when the mounted place of the sensor 41 slightly deviates from the position designed due to an error in assembling the image reading apparatus 10, the distance between the sensor 41 and the document P shifts from a desired distance, and blurring occurs in the read image. In order to avoid this trouble, an assembler of the image reading apparatus 10 makes adjustments in a manner described below.

When blurring occurs in the read image, the assembler moves the bump 51 in the x direction by means of the adjustment mechanism 52. Specifically, when the distance between the sensor 41 and the document P is shorter than a predetermined distance at which the image of the document comes into focus, the assembler moves the bump 51 such that the document P will separate from the principal surface 51. That is, the assembler moves the holder 54 to the positive side in the x direction and fixes the holder 54 to the side wall 100 of the housing by means of the screw 63. On the other hand, when the distance between the sensor 41 and the document P is longer than the predetermined distance at which the image of the document P comes into focus, the assembler moves the bump 51 such that the document P will come closer to the principal surface S1. That is, the assembler moves the holder 54 to the negative side in the x direction and fixes the holder 54 to the side wall 100 of the housing by means of the screw 63.

### Effects

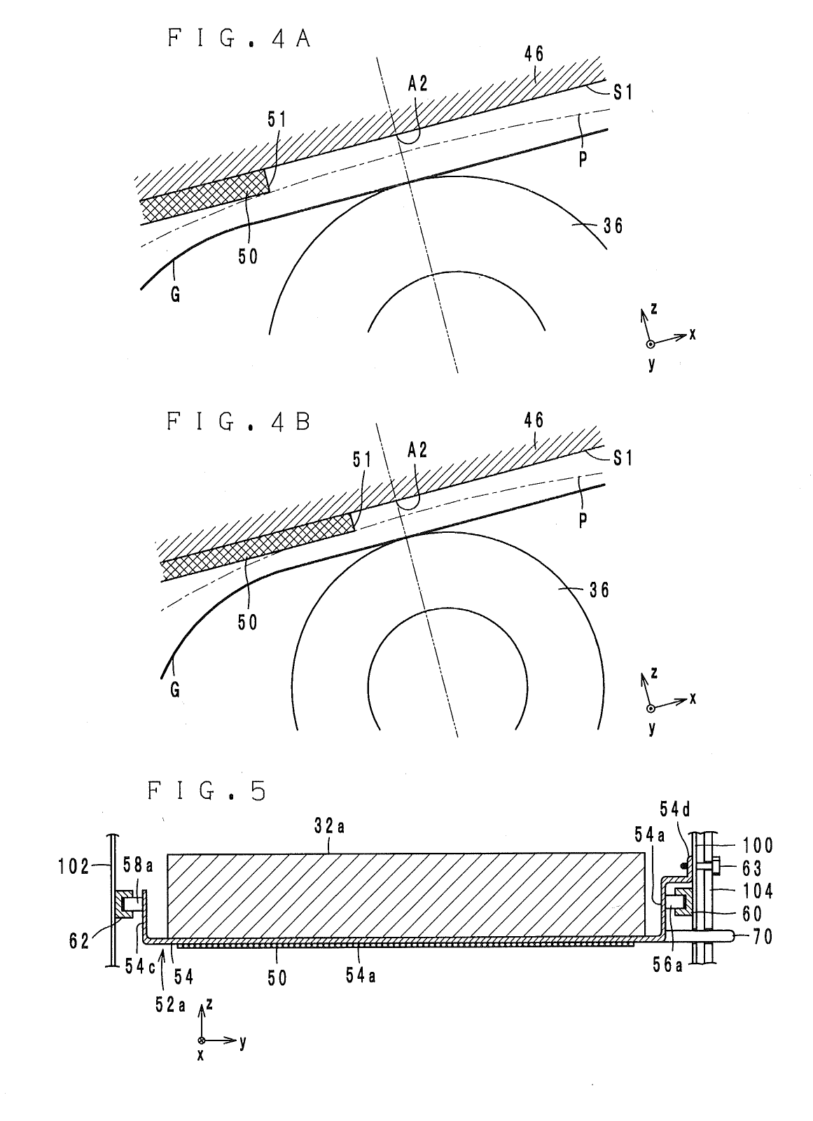

The image reading apparatus 10 according to the present embodiment can suppress occurrence of blurring in the read image. FIGS. 4A and 4B are enlarged views of the document P passing through the reading position A2. The bump 51 in FIG. 4A is located on the more negative side in the x direction than the bump 51 in FIG. 4B.

The image reading apparatus adopted with the CIS system has a shallow focal depth, and thus the apparatus has a problem that only a slight deviation of the distance between the document and the sensor brings the document out of focus. For example, errors in the positions of the sensor, the lens and the like due to variations in manufacturing of the image reading apparatus cause blurring in a read image.

In order to solve this problem, the adjustment mechanism 52 is provided in the image reading apparatus 10. The adjustment mechanism 52 is a mechanism for adjusting the distance in the x direction between the bump 51 and the reading position A2 for image reading of the document P. Specifically, as shown in FIGS. 4A and 4B, the adjustment mechanism 52 moves the bump member 50 in the x direction to move the bump 51 in the x direction. Then, as shown in FIG. 4A, when the bump 51 is located relatively in the negative side in the x direction, the document P is relatively significantly warped in the more positive side in the x direction than the bump 51. This makes the distance between the document P and the principal surface Si relatively short. On the other hand, as shown in FIG. 4B, when the bump 51 is located relatively in the positive side in the x direction, the document P is relatively slightly warped in the more positive side in the x direction than the bump 51. Therefore, in this case, the distance between the document P and the principal surface S1 is relatively large.

As thus described, the bump 51 is moved by the adjustment mechanism 52, thereby permitting adjustments of the position of the document P in the z direction at the reading position A2. Therefore, in the image reading apparatus 10, the distance between the sensor 41 and the document P can be adjusted to an appropriate distance. As a result, in the image reading apparatus 10, occurrence of blurring in the read image can be suppressed.

### First Modification

Next, an image reading apparatus 10a according to a first modification will be described with reference to the drawings. FIG. 5 is a sectional structural view of a reading unit 32a of the first modified image reading apparatus 10a. It is to be noted that FIG. 1 also shows the constitution of the image reading apparatus 10a.

As described below, in the image reading apparatus 10a, the adjustment mechanism 52a is configured to be operable from the outside of the image reading apparatus 10a. In the image reading apparatus 10a, an outer plate 104 is located in the positive side from the housing 100 in the y direction. The outer plate 104 is a panel constituting the front surface of the image reading apparatus 10a.

As shown in FIG. 5, the adjustment mechanism 52a is further provided with a lever 70. The lever 70 extends from the side section 54a of the holder 54 to the positive side in the y direction, and protrudes outside the image reading apparatus 10 through the housing 100 and the outer plate 104. Therefore, by sliding the lever 70 in the x direction, it is possible to slide the holder 54 in the x direction.

Further, in the image reading apparatus 10a, the screw 63 is screwed into the holder 54 through the outer plate 104 and the housing 100, from the outside of the image reading apparatus 10a to fix the holder 54 to the outer plate 104 and the housing 100. As thus described, in the image reading apparatus 10a, the adjustment mechanism 52a can be operated from the outside of the image reading apparatus 10a, and the holder 54 can be fixed from the outside of the image reading apparatus 10a.

Similarly to the image reading apparatus 10, the first modified image reading apparatus 10a can suppress occurrence of blurring due to errors in assembling the image reading apparatus 10a.

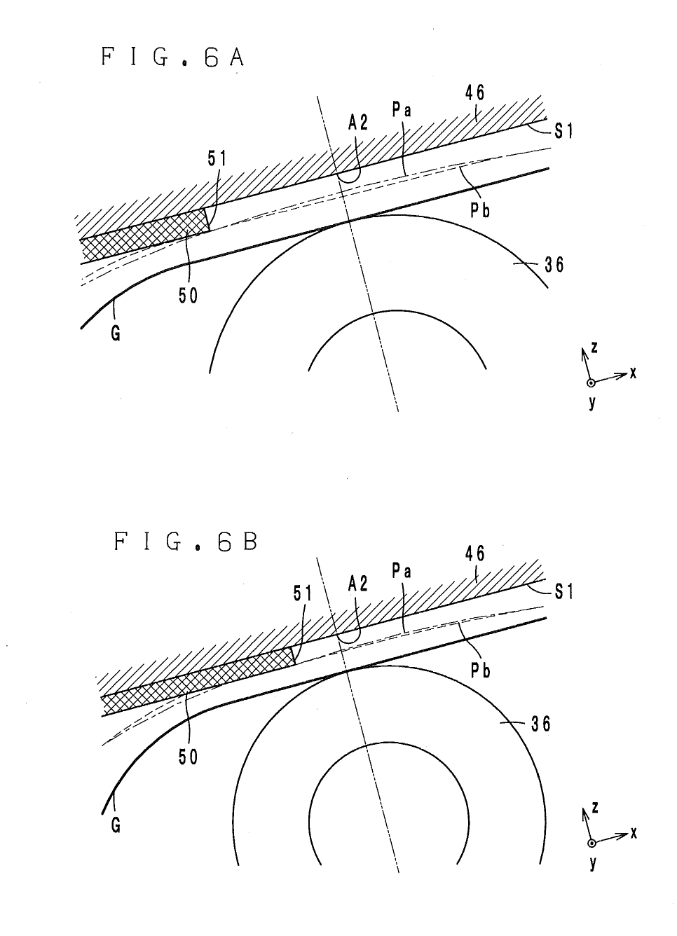

Further, the image reading apparatus 10a can suppress occurrence of blurring in the read images due to variations in stiffness of the documents P. FIGS. 6A and 6B are enlarged views of documents Pa and Pb passing through the reading position A2. The bump 51 in FIG. 6A is located in the more negative side in the x direction than the bump 51 in FIG. 6B.

The document Pa is a relatively hard-to-break document, e.g., cardboard, or the like. The document Pb is a relatively non-stiff document, e.g., ordinary paper, or the like. As shown in FIG. 6A, since the document Pa is relatively stiff, although the document Pa is in contact with the bump 51, the document Pa is relatively significantly warped in the more positive side in the x direction than the bump 51. This makes the distance between the document Pa and the principal surface S1 relatively short. On the other hand, as shown in FIG. 6B, the document Pb is put down by the bump 51 since the document Pb is relatively non-stiff, and is relatively slightly warped in the more positive side in the x direction than the bump 51. Therefore, the distance between the document Pa and the principal surface S1 is relatively large. As thus described, the distance between the document P (Pa, Pb) and the principal surface S1 changes, depending on the stiffness of the document P (Pa, Pb). This results in occurrence of blurring in the read image on either the document Pa or Pb. Hereinafter, it is assumed that blurring occurs in the read image of the document Pa.

Thereat, in the image reading apparatus 10a, the adjustment mechanism 52a is configured to be operable from the outside of the image reading apparatus 10a. Therefore, as shown in FIG. 6B, the user may move the lever 70 to the positive side in the x direction at the time of reading an image of a cardboard document, thereby to move the bump 51 to the positive side in the x direction. As shown in FIG. 6B, this brings the distance between the document Pa and the principal surface S1 close to the distance between the document Pb and the principal surface S1. As a result, occurrence of blurring in the read image of the document Pa can be suppressed.

### Second Modification

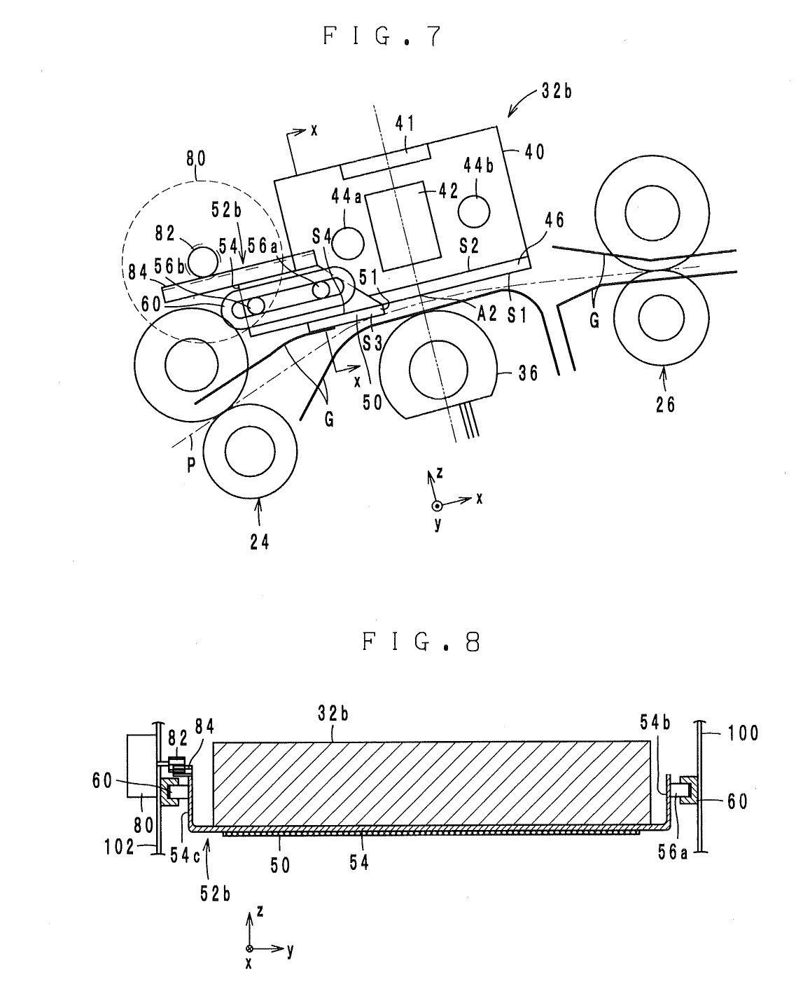

Next, an image reading apparatus 10b according to a second modification will be described with reference to the drawings. FIG. 7 is an enlarged view of a reading unit 32b and its vicinity. FIG. 8 is a sectional structural view of the reading unit 32b of the second modified image reading apparatus 10b. It is to be noted that FIG. 1 also shows the constitution of the image reading apparatus 10b.

The reading unit 32b of the image reading apparatus 10b is further provided with a motor 80 and a pinion gear 82 as shown in FIGS. 7 and 8. Further, an adjustment mechanism 52b is provided with a rack gear 84, as shown in FIGS. 7 and 8.

The motor 80 and the pinion gear 82 form a drive unit for the adjustment mechanism 52b. The motor 80 is fixed to the side wall 102 of the housing as shown in FIG. 8. The pinion gear 82 is fixed to the tip of a shaft of the motor 80.

As shown in FIGS. 7 and 8, the rack gear 84 is fixed to the end of the side section 54c of the holder 54 in the positive side in the z direction, and the rack gear 84 extends in the x direction. Then, the pinion gear 82 and the rack gear 84 engage with each other, to constitute a rack-and-pinion. In this structure, when the motor 80 drives the pinion gear 82 to rotate, the rack gear 84 moves in the x direction. Accordingly, the holder 54 moves in the x direction, and and the bump member 50 moves in the x direction.

Next, an operation of the image reading apparatus 10b will be described. In the image reading apparatus 10b, the sensor Sen acquires information on the stiffness of the document P (information as to whether the document P is cardboard or ordinary paper). The control section 11 makes the motor 80 actuate the adjustment mechanism 52b based on the information acquired by the sensor Sen. Specifically, the control section 11 makes the motor 80 actuate the adjustment mechanism 52b such that the distance in the x direction between the bump 51 and the reading position A1 becomes shorter as the document P becomes stiffer. For example, when the document P is ordinary paper, the control section 11 moves the bump 51 from a position as a reference to the positive side in the x direction by a distance L1. On the other hand, when the document P is a cardboard, the control section 11 moves the bump 51 from the position as the reference to the positive side in the x direction by a distance L2 (>L1). This automatically suppress occurrence of blurring in the read image in the document reading apparatus 10b. In the image reading apparatus 10b, the moving distance of the bump 51 may be adjusted in multiple stages in accordance with the information on the stiffness of the document P.

In addition, in the image reading apparatus 10b, the control section 11 acquires the information on the stiffness of the document P (information as to whether the document P is cardboard or ordinary paper) from the sensor Sen, but may acquire the information, for example, from an operation panel where the user inputs information about the kind of the document P.

Further, in the image reading apparatuses 10, 10a and 10b, the adjustment mechanisms 52, 52a and 52b move the bump member 50 in the x direction, but may move the sensor 41 in the x direction. Movement of the sensor 41 in the x direction leads to movement of the reading position A2 in the x direction, whereby the distance in the x direction between the bump 51 and the reading position A2 for image reading of the document P is adjusted.

Although the present invention has been described in connection with the preferred embodiment above, it is to be noted that various changes and modifications are possible to those who are skilled in the art. Such changes and modifications are to be understood as being within the scope of the invention.

What is claimed is:

1. An image reading apparatus comprising:
a transparent plate having a first principal surface and a second principal surface;
a carriage unit that carries a document such that the document passes through over the first principal surface;
a reading unit that is opposed to the second principal surface and reads the document passing through a reading position on the first principal surface;
a bump member that forms a bump on the first principal surface at a position more upstream than the reading position in a document carrying direction; and
an adjustment unit for adjusting a distance in the carrying direction between the bump and the reading position for image reading of the document.

2. The image reading apparatus according to claim 1, wherein the reading unit reads the document by a contact image sensor system.

3. The image reading apparatus according to claim 1, wherein the adjustment unit is a mechanism to move the bump member in the carrying direction.

4. The image reading apparatus according to claim 1, wherein the adjustment unit is configured so as to be operable from an outside of the image reading apparatus.

5. The image reading apparatus according to claim 1, further comprising a drive unit that actuates the adjustment unit.

6. The image reading apparatus according to claim 5, further comprising
an information acquiring unit that acquires information on stiffness of the document; and
a control section that makes the drive unit actuate the adjustment unit based on the information on stiffness of the document.

7. The image reading apparatus according to claim 6, wherein the control section makes the drive unit actuate the adjustment unit such that the distance in the carrying direction between the bump and the reading position becomes shorter as the document becomes stiffer.

8. The image reading apparatus according to claim 1, wherein the document is carried in a curved state so as to protrude toward the transparent plate.
